(19) United States
(12) Patent Application Publication
(10) Pub. No.: US 2003/0067111 A1
(43) Pub. Date: Apr. 10, 2003

(54) Game controller lap attachment device

(75) Inventors: Fred Swan, Castro Valley, CA (US); John R. Faust, Burlingame, CA (US); Ming Yu, Taipei (TW); Wayne Tsai, Shin-Chu (TW); Rico Zorkendorfer, San Francisco, CA (US); Pontus Wahlgren, San Francisco, CA (US); Frances Samalionis, London (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LOGITECH EUROPE S.A., Moulin du Choc (CH)

(21) Appl. No.: 10/144,243

(22) Filed: May 10, 2002

Related U.S. Application Data
(63) Continuation-in-part of application No. 29/149,479, filed on Oct. 9, 2001.
(63) Continuation-in-part of application No. 29/149,532, filed on Oct. 9, 2001, now Pat. No. D463764.

(51) Int. Cl. A63B 71/00; A63F 13/00

(52) U.S. Cl. 273/148 R; 463/36

(57) ABSTRACT

Embodiments of the present invention provide a device and a method of supporting a game controller such as a steering wheel without mounting it to a stable physical structure such as a desk or table. The game controller is supported on a lap attachment device which is clasped between the left thigh and the right thigh of the user to provide adequate support needed for the desired game playing experience. In accordance with an aspect of the present invention, a game controller lap attachment device comprises a base having a left side and a right side, which are configured to be clasped by a left thigh of a user on the left side of the base and a right thigh of the user on the right side of the base. A game controller support is connected with the base and is configured to support a game controller thereon to be operated by the user.

### CROSS-REFERENCES TO RELATED APPLICATIONS

This application is a continuation-in-part and claims the benefit of U.S. Design Patent Application Nos. 29/149,479 and 29/149,532, filed Oct. 9, 2001, the entire disclosures of which are incorporated herein by reference.

### BACKGROUND OF THE INVENTION

The present invention relates generally to game control equipment and, more particularly, to a device and a method for supporting a game controller on the lap of the user.

Certain game controllers such as steering wheels need a sturdy support to provide the user with the desired game playing experience. One conventional way of providing support for a game controller such as a steering wheel is to attach the game controller to a desk, a table, or the like. The need to mount the game controller to a stable, typically large, physical structure such as a desk or a table limits the versatility and mobility of the game controller. It may be inconvenient, for instance, to provide a support structure in the living room for the game controller or to attach and detach the game controller from the support structure before and after each play.

### BRIEF SUMMARY OF THE INVENTION

Embodiments of the present invention provide a device and a method of supporting a game controller such as a steering wheel without mounting it to a stable physical structure such as a desk or a table. The game controller is supported on a lap attachment device which is clasped between the left thigh and the right thigh of the user to provide adequate support needed for the desired game playing experience. The lap attachment device provides stable support for the game controller on the lap or thighs of the user while the user clasps the lap attachment device between the thighs.

In accordance with an aspect of the present invention, a game controller lap attachment device comprises a base having a left side and a right side, which are configured to be clasped by a left thigh of a user on the left side of the base and a right thigh of the user on the right side of the base. A game controller support is connected with the base and is configured to support a game controller thereon to be operated by the user.

In some embodiments, the left side comprises a left concave surface and the right side comprises a right concave surface. The left concave surface is disposed to contact a portion of the left thigh adjacent a left knee of the user, and the right concave surface is disposed to contact a portion of the right thigh adjacent a right knee of the user. The left side further comprises a left proximal surface configured to be disposed away from the left knee and toward a groin of the user, and the right side further comprises a right proximal surface configured to be disposed away from the right knee and toward the groin of the user. The left proximal surface and the right proximal surface may be slanted inwardly in a rearward direction toward the groin of the user. The left concave surface and the right concave surface may be slanted inwardly in a forward direction to be away from the groin of the user.

In specific embodiments, the game controller support is connected with the base to be disposed above the left concave surface and the right concave surface of the base, and includes a left extension configured to rest on a left thigh of the user and a right extension configured to rest on a right thigh of the user. The left extension is configured to extend from a region above the left concave surface leftward and rearward toward a left hip of the user, and the right extension is configured to extend from a region above the right concave surface rightward and rearward toward a right hip of the user. The game controller support may be detachably connected with the base. The game controller support has at least one slot configured to receive a hook of the game controller.

In accordance with another aspect of the present invention, a game controller lap attachment device comprises a base having a left side and a right side, which are configured to be clasped by a left thigh of a user on the left side of the base and a right thigh of the user on the right side of the base. The left side comprises a left distal surface which is disposed to contact a portion of the left thigh adjacent a left knee of the user. The right side comprises a right distal surface which is disposed to contact a portion of the right thigh adjacent a right knee of the user. A game controller support is connected with the base and is configured to support a game controller thereon to be operated by the user.

In accordance with another aspect of the invention, a method of supporting a game controller on a lap of a user comprises providing a base having a left side and a right side and a game controller support connected with the base, clasping the base between a left thigh of a user on the left side of the base and a right thigh of the user on the right side of the base, and supporting a game controller on the game controller support to be operated by the user.

In some embodiments, the method further comprises supporting a left extension of the game controller support with the left thigh of the user and supporting a right extension of the game controller support with the right thigh of the user. Clasping the base comprises contacting a left distal surface on the left side of the base with a portion of the left thigh adjacent a left knee of the user, contacting a right distal surface on the right side of the base with a portion of the right thigh adjacent a right knee of the user, contacting a left proximal surface on the left side of the base with a portion of the left thigh away from the left knee and toward a groin of the user, and contacting a right proximal surface on the right side of the base with a portion of the right thigh away from the right knee and toward the groin of the user.

### BRIEF DESCRIPTION OF THE DRAWINGS

FIG. 1 is a top plan view of a game controller lap attachment device according to an embodiment of the present invention;

FIG. 2 is front elevational view of the lap attachment device of FIG. 1;

FIG. 3 is a right side elevational view of the lap attachment device of FIG. 1, the left side elevational view being a mirror image thereof;

FIG. 4 is a r ear elevational view of the lap attachment device of FIG. 1;

FIG. 5 is a bottom plan view of the lap attachment device of FIG. 1;

FIG. 6 is a perspective view of a steering wheel device according to an embodiment of the present invention;

FIG. 7 is a front elevational view of the steering wheel device of FIG. 6;

FIG. 8 is a right side elevational view of the steering wheel device of FIG. 6, the left side elevational view being a mirror image thereof; and

FIG. 9 is a right side elevational view of the steering wheel device of FIG. 6 mounted on the game controller lap attachment device of FIG. 1.

### DETAILED DESCRIPTION OF THE INVENTION

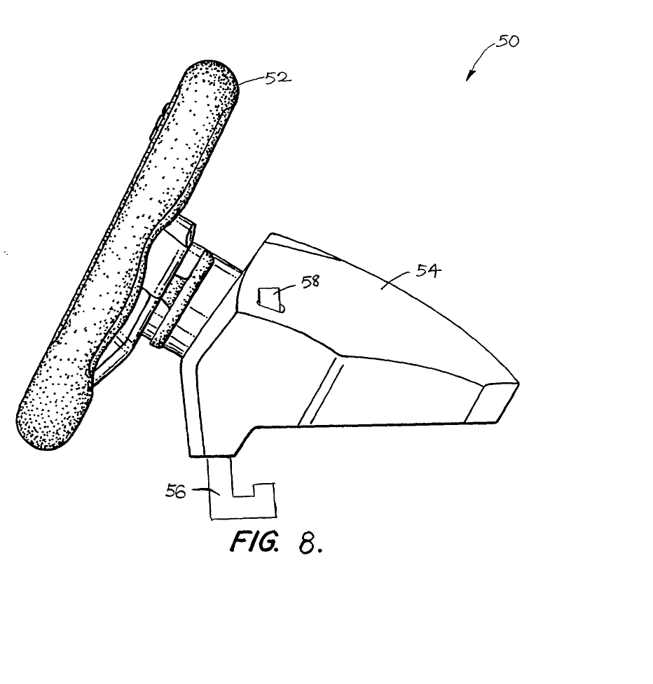

FIGS. 1-5 show a game controller lap attachment device 10 for attaching a game controller such as a steering wheel shown in FIGS. 6-8 and supporting the game controller on the lap of the user. The lap attachment device 10 includes a base 12 which is to be placed between the thighs of the user and be clasped therebetween. A game controller support 14 is connected with the base 12 for supporting the game controller thereon to be operated by the user.

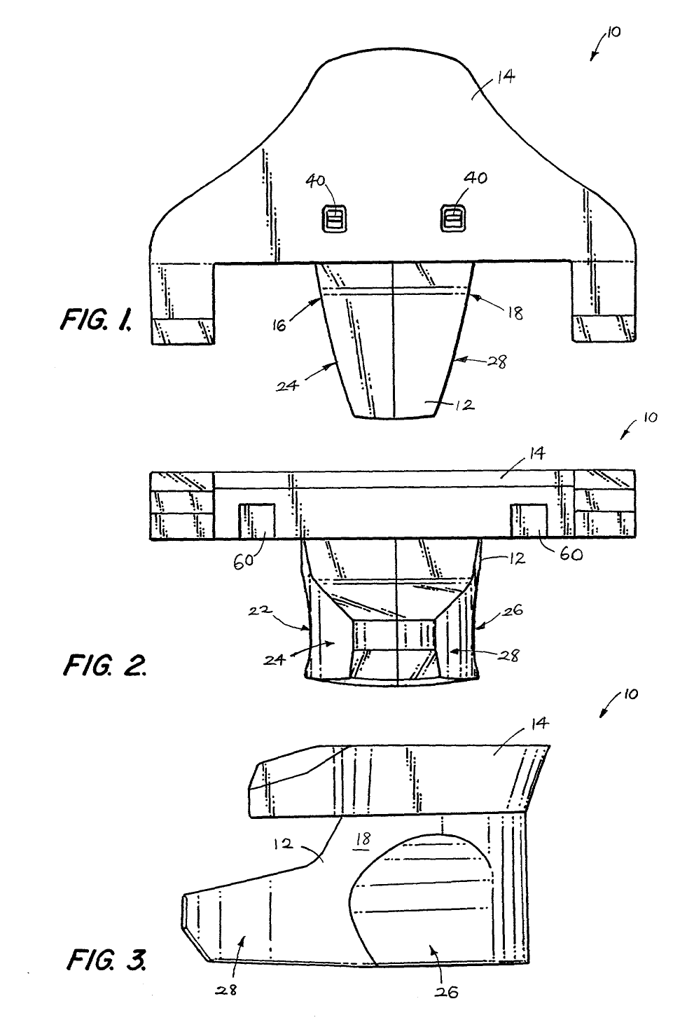

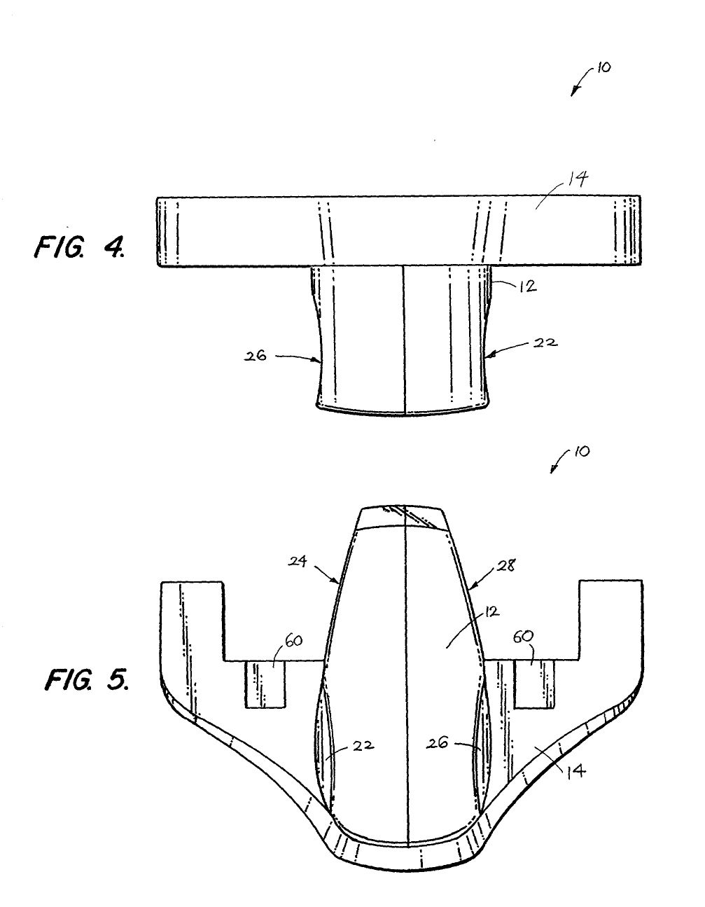

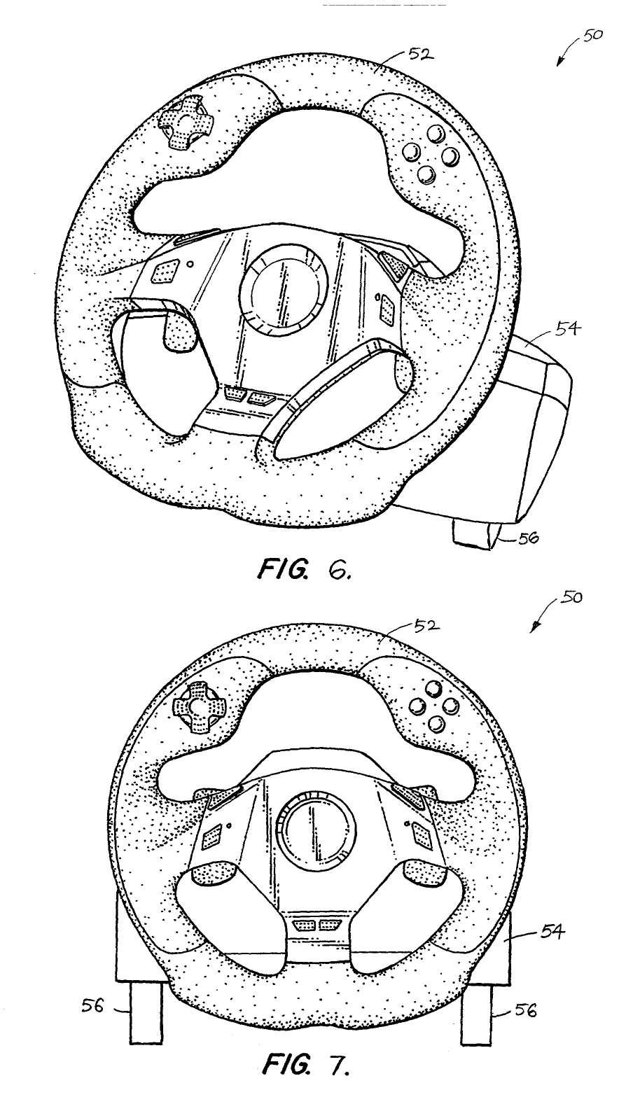

As shown in FIG. 1, the base 12 includes a left side 16 to be contacted by the left thigh and a right side 18 to be contacted by the right thigh of the user. The left side 16 includes a left distal surface 22 and a left proximal surface 24, and the right side 18 includes a right distal surface 26 and a right proximal surface 28 (as best seen in FIGS. 3 and 5). In the embodiment shown, the left distal surface 22 and the right distal surface 26 are concave, as shown in FIGS. 2 and 4. These distal surfaces 22, 26 are concave in the up-down direction to more closely match the shapes of typical thighs and to provide a more secure clasping of the base 12 between the thighs.

The left distal surface 22 is disposed to contact a portion of the left thigh adjacent or close to the left knee of the user, and the right distal surface 26 is disposed to contact a portion of the right thigh adjacent or close to the right knee of the user. The left proximal surface 24 is disposed away from the left knee and toward the groin of the user to contact a proximal portion of the left thigh of the user. The right proximal surface 28 is disposed away from the right knee and toward the groin of the user to contact a proximal portion of the right thigh of the user. As best seen in FIGS. 1 and 5, the left proximal surface 24 and the right proximal surface 28 are desirably slanted inwardly in a rearward direction toward the groin of the user. This tends to better match the profile of the proximal portions of typical thighs. The left distal surface 22 and right distal surface 26 may be generally parallel in the rearward-forward direction, or be slightly slanted inwardly in the forward direction away from the groin of the user.

The support 14 may be detachably connected with the base 12, so that the support 14 and the base 12 may be disassembled for ease of storage. The base 12 and the support 14 may be connected together by any suitable mechanism such as a self-locking mechanism. FIG. 1 shows a pair of release latches 40 that can be used to release the attachment or locking mechanism which is coupled with the release latches 40 and disassemble the support 14 from the base 12.

As shown in FIGS. 1, 3, and 5, the game controller support 14 is connected with the distal portion of the base 12 so as to be disposed above the left distal surface 22 and the right distal surface 26 of the base 12. The support 14 includes a left extension or arm 32 and a right extension or arm 34. The left extension 32 extends from a region above the left distal surface 22 of the base 12 leftward and rearward toward the left hip of the user. The right extension 34 extends from a region above the right distal surface 26 of the base 12 rightward and rearward toward the right hip of the user. The left extension 32 rests on the left thigh and the right extension 36 rests on the right thigh of the user. The clasping of the base 12 between the thighs and the support provided to the game controller support 14 by resting on the thighs desirably ensure adequate support to the game controller for the game playing experience of the user.

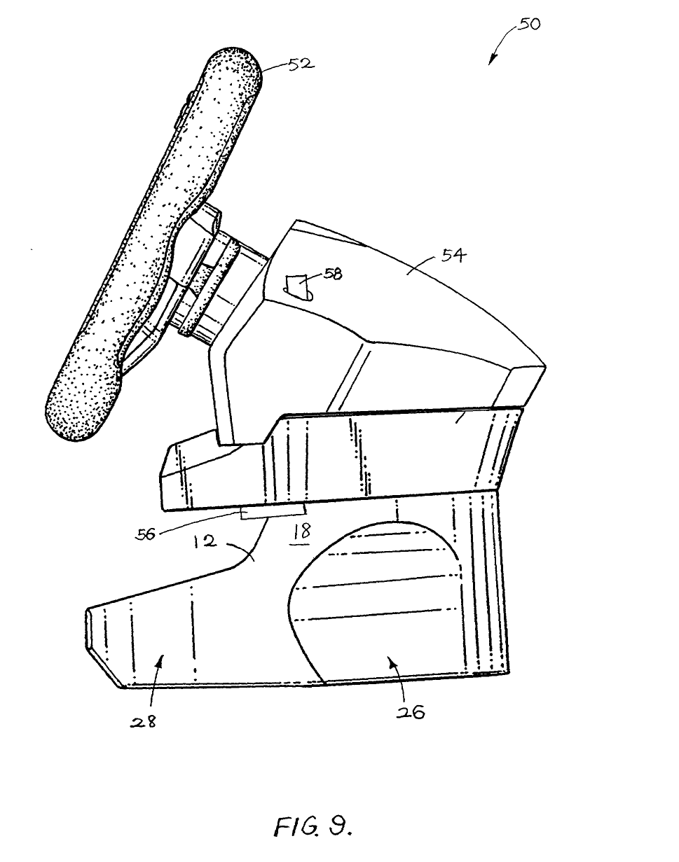

FIGS. 6-8 show an example of a game controller in the form of a steering wheel device 50 which may be attached to the game controller lap attachment device 10 of FIGS. 1-5. The steering wheel device 50 includes a steering wheel 52 connected to a body 54. A pair of adjustable hooks 56 protrude downward from the body 54 to engage a pair of slots 60 provided in the game controller support 14 of the lap attachment device 10 (see slots 60 in FIGS. 2 and 5). The hooks 56 extend through the body 54 of the steering wheel device 50 to provide adjustment portions 58 above the body 54 of the steering wheel device 50. The hooks 56 may be coupled to the body 54 by threaded connections. The hooks 56 are adjustable upward and downward, for instance, by turning the adjustment portions 58. To mount the steering wheel device 50 to the lap attachment device 10, the hooks 56 are first adjusted downward below the slots 60 of the game controller support 14 until the steering wheel device 50 is placed on top of the game controller support 14 and the hooks 56 are aligned with the slots 60. The adjustment portions 58 are then turned to move the hooks 56 upward to engage and be tightened against the slots 60, as shown in FIG. 9. It is understood that other clamping mechanisms having different shapes and configurations or other types of attachment mechanisms may be used instead.

The above-described arrangements of apparatus and methods are merely illustrative of applications of the principles of this invention and many other embodiments and modifications may be made without departing from the spirit and scope of the invention as defined in the claims. For example, the game controller lap attachment device 10 may be used for attaching other game controllers, and may employ different mechanisms for attaching the game controller to the lap attachment device 10. The scope of the invention should, therefore, be determined not with reference to the above description, but instead should be determined with reference to the appended claims along with their full scope of equivalents.

What is claimed is:

1. A game controller lap attachment device comprising:
a base having a left side and a right side, which are configured to be clasped by a left thigh of a user on the left side of the base and a right thigh of the user on the right side of the base; and
a game controller support connected with the base and being configured to support a game controller thereon to be operated by the user.

2. The device of claim 1 wherein the left side comprises a left concave surface and the right side comprises a right concave surface.

3. The device of claim 2 wherein the left concave surface is disposed to contact a portion of the left thigh adjacent a left knee of the user, and the right concave surface is disposed to contact a portion of the right thigh adjacent a right knee of the user.

4. The device of claim 3 wherein the left side further comprises a left proximal surface configured to be disposed away from the left knee and toward a groin of the user, and the right side further comprises a right proximal surface configured to be disposed away from the right knee and toward the groin of the user.

5. The device of claim 4 wherein the left proximal surface and the right proximal surface are slanted inwardly in a rearward direction toward the groin of the user.

6. The device of claim 3 wherein the game controller support is connected with the base to be disposed above the left concave surface and the right concave surface of the base, and includes a left extension configured to rest on a left thigh of the user and a right extension configured to rest on a right thigh of the user.

7. The device of claim 6 wherein the left extension is configured to extend from a region above the left concave surface leftward and rearward toward a left hip of the user, and the right extension is configured to extend from a region above the right concave surface rightward and rearward toward a right hip of the user.

8. The device of claim 2 wherein the left concave surface and the right concave surface are slanted inwardly in a forward direction to be away from the groin of the user.

9. The device of claim 1 wherein the game controller support is detachably connected with the base.

10. The device of claim 1 wherein the game controller support has at least one slot configured to receive a hook of the game controller.

11. The device of claim 1 wherein the game controller support includes a left extension configured to rest on a left thigh of the user and a right extension configured to rest on a right thigh of the user.

12. The device of claim 11 wherein the left extension is configured to extend from a region above a left knee of the user leftward and rearward toward a left hip of the user, and the right extension is configured to extend from a region above a right knee of the user rightward and rearward toward a right hip of the user.

13. A game controller lap attachment device comprising:
a base having a left side and a right side, which are configured to be clasped by a left thigh of a user on the left side of the base and a right thigh of the user on the right side of the base, the left side comprising a left distal surface which is disposed to contact a portion of the left thigh adjacent a left knee of the user, the right side comprising a right distal surface which is disposed to contact a portion of the right thigh adjacent a right knee of the user; and
a game controller support connected with the base and being configured to support a game controller thereon to be operated by the user.

14. The device of claim 13 wherein the left distal surface and the right distal surface are slanted inwardly in a forward direction to be away from the groin of the user.

15. The device of claim 13 wherein the left side of the base comprises a left proximal surface which is configured to be disposed away from the left knee and toward a groin of the user, and wherein the right side of the base comprises a right proximal surface which is configured to be disposed away from the right knee and toward the groin of the user.

16. The device of claim 15 wherein the left proximal surface and the right proximal surface are slanted inwardly in a rearward direction toward the groin of the user.

17. The device of claim 13 wherein the game controller support comprises a left extension configured to rest on the left thigh of the user and a right extension configured to rest on the right thigh of the user, the left extension being configured to extend from a region above the left distal surface leftward and rearward toward a left hip of the user, the right extension being configured to extend from a region above the right distal surface rightward and rearward toward a right hip of the user.

18. A method of supporting a game controller on a lap of a user, the method comprising:
providing a base having a left side and a right side and a game controller support connected with the base;
clasping the base between a left thigh of a user on the left side of the base and a right thigh of the user on the right side of the base;
supporting a game controller on the game controller support to be operated by the user.

19. The method of claim 18 further comprising supporting a left extension of the game controller support with the left thigh of the user and supporting a right extension of the game controller support with the right thigh of the user.

20. The method of claim 18 wherein clasping the base comprises:
contacting a left distal surface on the left side of the base with a portion of the left thigh adjacent a left knee of the user;
contacting a right distal surface on the right side of the base with a portion of the right thigh adjacent a right knee of the user;
contacting a left proximal surface on the left side of the base with a portion of the left thigh away from the left knee and toward a groin of the user; and
contacting a right proximal surface on the right side of the base with a portion of the right thigh away from the right knee and toward the groin of the user.
